(19) United States
(12) Patent Application Publication
(10) Pub. No.: US 2017/0332331 A1
(43) Pub. Date: Nov. 16, 2017

(54) DYNAMIC ALLOCATION OF WIRELESS CHANNELS FOR APPLICATIONS

(71) Applicant: ALTEROS, INC., Stow, OH (US)

(72) Inventors: Robert T. GREEN, III, Streetsboro, OH (US); Brian K. FAIR, Boyds, MD (US); Jacquelynn A. GREEN, Streetsboro, OH (US)

(21) Appl. No.: 15/590,915

(22) Filed: May 9, 2017

Related U.S. Application Data
(60) Provisional application No. 62/334,331, filed on May 10, 2016.

(51) Int. Cl. H04W 52/02; H04W 72/04; H04W 40/00; H04W 76/04; H04W 16/14

(52) U.S. Cl. CPC H04W 52/0283; H04W 76/048; H04W 16/14; H04W 40/005; H04W 72/0453

(57) ABSTRACT

One embodiment provides a method for dynamic allocation of wireless channels for applications. The method comprises receiving first control data indicating a first wireless media device selected from multiple wireless media devices to activate at a first pre-determined time. The method further comprises, based on the first control data and information indicating transmission channels available for use by the multiple wireless media devices, dynamically assigning a first transmission channel to the first wireless media device, such that no two wireless media devices are active on the same transmission channel at the same time. The method further comprises wirelessly transmitting a first control command to the first wireless media device. The first control command comprises a first instruction for the first wireless media device to power on at the first pre-determined time and wirelessly transmit data on the first transmission channel.

### CROSS REFERENCE TO RELATED APPLICATIONS

This application claims priority from U.S. Provisional Patent Application Ser. No. 62/334,331, filed on May 10, 2016, incorporated herein by reference.

### TECHNICAL FIELD

One or more embodiments relate generally to digital media networking, and in particular, a method and system for dynamically allocating wireless channels for applications (e.g., audio applications, video applications, and other types of media applications).

### BACKGROUND

A wireless electronic device may be used to wirelessly transmit data to one or more other electronic devices (e.g., another wireless electronic device, a non-wireless electronic device, etc.) without use of a physical cable. A wireless microphone is an example wireless electronic device used for transmitting sound to a broadcast/media device/system, such as an amplifier or a recording device. Wireless microphones may operate in various different spectrum bands. Wireless microphones may be designed to operate on a discrete set of frequencies within a spectrum band, or they may cover an entire range of frequencies in the band.

### SUMMARY

One embodiment provides a method for dynamic allocation of wireless channels for applications. The method comprises receiving first control data indicating a first wireless media device selected from multiple wireless media devices to activate at a first pre-determined time. The method further comprises, based on the first control data and information indicating transmission channels available for use by the multiple wireless media devices, dynamically assigning a first transmission channel to the first wireless media device, such that no two wireless media devices are active on the same transmission channel at the same time. The method further comprises wirelessly transmitting a first control command to the first wireless media device. The first control command comprises a first instruction for the first wireless media device to power on at the first pre-determined time and wirelessly transmit data on the first transmission channel.

These and other features, aspects and advantages of the present invention will become understood with reference to the following description, appended claims and accompanying figures.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an example wireless system for dynamic allocation of wireless channels for applications, in accordance with one embodiment;

FIG. 2 illustrates another example wireless system for dynamic allocation of wireless channels for applications, wherein the system includes a feedback loop, in accordance with one embodiment;

FIG. 3 illustrates another example wireless system for dynamic allocation of wireless channels for applications, wherein the system includes a signal combining device, in accordance with one embodiment;

FIG. 4 illustrates another example wireless system for dynamic allocation of wireless channels for applications, wherein the system includes a signal router, in accordance with one embodiment;

FIG. 5 illustrates another example wireless system for dynamic allocation of wireless channels for applications, wherein the system includes a network connection, in accordance with one embodiment;

FIG. 6 illustrates another example wireless system for dynamic allocation of wireless channels for applications, wherein the system provides a signal combining device with an on-board control surface, in accordance with one embodiment;

FIG. 7 illustrates another example wireless system for dynamic allocation of wireless channels for applications, wherein the system provides a transmitter controller integrated with a channel receiver, in accordance with one embodiment;

FIG. 8 illustrates another example wireless system for dynamic allocation of wireless channels for applications, wherein the system transfers signals over a network connection, in accordance with one embodiment;

FIG. 9 illustrates another example wireless system for dynamic allocation of wireless channels for applications, wherein the system provides a channel receiver with an on-board control surface, in accordance with one embodiment;

FIG. 10 illustrates another example wireless system for dynamic allocation of wireless channels for applications, wherein the system transfers signals over a communication bus, in accordance with one embodiment;

FIG. 11 illustrates a flowchart of an example process for dynamic allocation of wireless channels for applications, in accordance with one embodiment;

FIG. 12 illustrates a flowchart of another example process for dynamic allocation of wireless channels for applications, in accordance with one embodiment; and

FIG. 13 is a high-level block diagram showing an information processing system comprising a computer system useful for implementing the disclosed embodiments.

The detailed description explains the preferred embodiments of the invention together with advantages and features, by way of example with reference to the drawings.

### DETAILED DESCRIPTION

One or more embodiments relate generally to digital media networking, and in particular, a method and system for dynamically allocating wireless channels for applications (e.g., audio applications, video applications, and other types of media applications). One embodiment provides a method for dynamic allocation of wireless channels for applications. The method comprises receiving first control data indicating a first wireless media device selected from multiple wireless media devices to activate at a first pre-determined time. The method further comprises, based on the first control data and information indicating transmission channels available for use by the multiple wireless media devices, dynamically assigning a first transmission channel to the first wireless media device, such that no two wireless media devices are active on the same transmission channel at the same time. The method further comprises wirelessly transmitting a first control command to the first wireless media device. The first control command comprises a first instruction for the first wireless media device to power on at the first pre-determined time and wirelessly transmit data on the first transmission channel.

For expository purposes, the term “media device” as used herein refers to a professional broadcast/media device/system, such as a professional audio device/system or a professional video device/system, etc. Examples of media devices include, but are not limited to, microphones, wireless microphones, amplifiers, audio mixers, recording devices, etc. Examples of different users/operators of media devices include, but are not limited to, broadcasters, programming networks, theaters, venues (e.g., sports venues, music venues, etc.), festivals, fairs, film studios, conventions, corporate events, houses of worship, sports leagues, schools, etc.

For expository purposes, the term “wireless media device” as used herein refers to a media device capable of exchanging data with another device (e.g., another media device) wirelessly (i.e., without need of a physical cable). For example, a wireless microphone is a wireless media device used to capture and transmit audio data (i.e., sound) to another device (e.g., an amplifier, a recording device, etc.) wirelessly. Examples of wireless microphones include, but are not limited to, hand-held or body-worn wireless microphones, in-ear monitors, media devices used for cueing on-air talent, intercom systems for backstage communications, etc.

In recent times, the amount of spectrum traditionally available for wireless microphones and similar wireless electronic devices (e.g., wireless intercoms, wireless in-ear monitors, etc.) in ultra high frequency (UHF) and very high frequency (VHF) bands is decreasing as one or more portions of the spectrum is reclaimed and repurposed for new wireless services by government mandate. For example, in 2010, the Federal Communications Commission (FCC) prohibited operation of wireless microphones and similar devices in the 700 MHz band (i.e., 698-806 MHz). As another example, in 2014, the FCC adopted rules to implement the broadcast television spectrum incentive auction, which will involve reorganizing existing television band and repurposing a portion of the UHF band for new wireless broadband services, which will no longer be available to wireless microphones. As a result of such limitations on the amount of spectrum available for wireless microphone use, there is a limited number of unique transmission channels (i.e., wireless channels) available for wireless microphone use during large-scale events.

Traditionally, when more spectrum was available for wireless microphone use, one-to-one assignment of a transmitter to a transmission channel (i.e., wireless channel) is enabled (i.e., each transmitter utilized at an event is assigned its own transmission channel). Enabling such one-to-one assignment at an event provides audio/sound operators at the event with the most stable and reliable channel plan that assures no audio interference during the event. As the amount of spectrum available for wireless microphone use has declined over time, it may not be feasible to allow one-to-one assignment at certain events (e.g., large-scale events) as the amount of spectrum available for wireless microphone use is not enough. As such, transmission channels available for wireless microphone use during such events must be shared between different transmitters utilized at the event. For example, a transmission channel assigned to a wireless microphone transmitter utilized by a vocalist during a musical act at an event may be shared with a wireless microphone transmitter utilized by a guitarist during a subsequent musical act at the event.

As the amount of spectrum available for wireless microphone use declines over time, sharing of transmission channels (“channel sharing”) becomes more and more common at large-scale events (e.g., music festivals, sporting events, etc.). Currently, channel sharing is managed/monitored by a person/entity responsible for/in-charge of transmitters utilized at an event (e.g., audio/sound operator, operator of the venue at which the event is held, wireless microphone operator, etc). The person/entity may have to make decisions with regards to channel sharing that are complex. For example, if multiple acts/performances share common transmission channels, delays may be scheduled between the acts/performance to allow enough time to elapse/pass for switching between transmitters assigned the common transmission channels.

During an event, an operator must follow a pre-determined channel sharing plan, and communicate closely to coordinate times when each transmitter is powered off and powered on (i.e., turn off times and turn on times). A misstep may result in audio interference that occurs when two transmitters operate on the same transmission channel simultaneously or a transmitter is powered off when it should be powered on and transmitting audio. As such, management of channel sharing is prone to human error and may result in a catastrophic failure during the event.

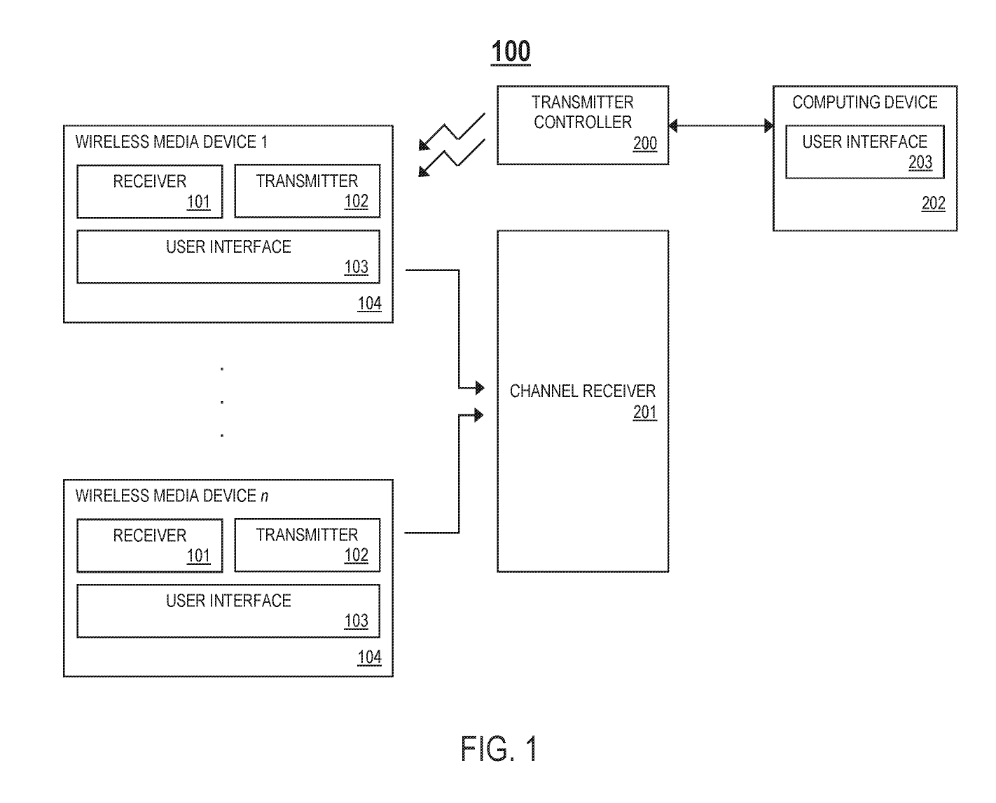

FIG. 1 illustrates an example wireless system 100 for dynamic allocation of wireless channels for applications, in accordance with one embodiment. The system 100 comprises multiple wireless media devices 104, such as WIRELESS MEDIA DEVICE 1, . . . , and WIRELESS MEDIA DEVICE n, wherein n>1. Each wireless media device 104 is associated with a particular application (e.g., an audio application, a video application, or another type of media application). In one embodiment, the system 100 is a wireless microphone system, and each wireless media device 104 is a wireless microphone.

Each wireless media device 104 comprises, but is not limited to, the following components: (1) a receiver unit 101 for wirelessly receiving data/signals (e.g., control commands), (2) a transmitter unit 102 for wirelessly transmitting data/signals (e.g., audio data/signals, video data/signals, etc.), and (3) a user interface (UI) 103 for configuring one or more parameters/settings for the wireless media device 104. Each wireless media device 104 is assigned a corresponding unique identifier (ID).

Transmission channels (i.e., wireless channels) available for the wireless media devices 104 may be divided using any type of channelization protocol, such as time-division multiple access (TDMA), frequency-division multiple access (FDMA), or code-division multiple access (CDMA).

The system 100 further comprises a channel receiver 201 for wirelessly receiving data/signals (e.g., audio data/signals, video data/signals, etc.) transmitted from each wireless media device 104. The channel receiver 201 is a media device. In one embodiment, the channel receiver 201 is an audio channel receiver.

The system 100 further comprises a transmitter controller 200 for communicating with and controlling each wireless media device 104. Specifically, the transmitter controller 200 is configured to: (1) receive control data from a computing device 202, and (2) based on the control data, selectively transmit one or more control commands wirelessly to one or more of the wireless media devices 104. In one embodiment, the computing device 202 comprises an electronic device, such as a laptop computer, a desktop computer, a tablet, a smart phone, etc. The computing device 202 is configured to exchange data (e.g., control data) with the transmitter controller 200 over a point-to-point connection (e.g., a wireless connection such as a WiFi connection or a cellular data connection, a wired connection, or a combination of the two). The computing device 202 may be operated by a user/operator tasked with managing the system 100 (e.g., an audio/sound operator).

In one embodiment, the control data indicates which of the wireless media devices 104 should be active (i.e., powered on) at a particular time during an event. Based on the control data and information indicative of transmission channels available for use by the wireless media devices 104, the transmission controller 200 dynamically allocates transmission channels for applications. For example, at a particular time during the event, the transmission controller 200 may assign a transmission channel to an active wireless media device 104 and a different transmission channel to a different active wireless media device 104, such that no two wireless media devices 104 are active on the same transmission channel at the same time. The active wireless media devices 104 may be associated with different applications (e.g., the active wireless media devices 104 include separate wireless microphone transmitters for a vocalist and a guitarist performing simultaneously).

The transmission controller 200 is configured to wirelessly transmit a control command to a particular/individual wireless media device 104 at a particular time. The control command comprises an instruction to the wireless media device 104 to adjust an operating mode (e.g., switch between a powered on or powered off mode) of the wireless media device 104. For example, the control command comprises, but is not limited to, at least one of the following: (1) an instruction to power off (i.e., turn off or deactivate) or power on (i.e., turn on or activate) at the particular time, or (2) an instruction to wirelessly transmit data/signals (e.g., audio data/signals, video data/signals, etc.) on a particular transmission channel assigned to the wireless media device 104.

The total number of wireless media devices 104 (i.e., n) in the system 100 may exceed the number of transmission channels available for use by the wireless media devices 104 as long as the total number of active wireless media devices 104 (i.e., wireless media devices 104 that are powered on) at any particular time during the event never exceeds the number of transmission channels available.

In one embodiment, the computing device 202 comprises a user interface 203 configured to provide information and one or more functionalities that a user/operator (e.g., an audio/sound operator) tasked with managing the system 100 may utilize for management of the system 100. The functionalities include, but are not limited to, the following: (1) selecting/communicating with one or more wireless media devices 104 the user/operator needs to have active (i.e., powered on and transmitting signals) at a particular time during an event, and (2) managing assignment of transmission channels available for use by the wireless media devices 104. For example, the user/operator may select which of the wireless media devices 104 should be active (i.e., powered on) at a particular time during the event via the user interface 203. Control data transmitted to the transmitter controller 200 may be based on input provided by the user/operator via the user interface 203.

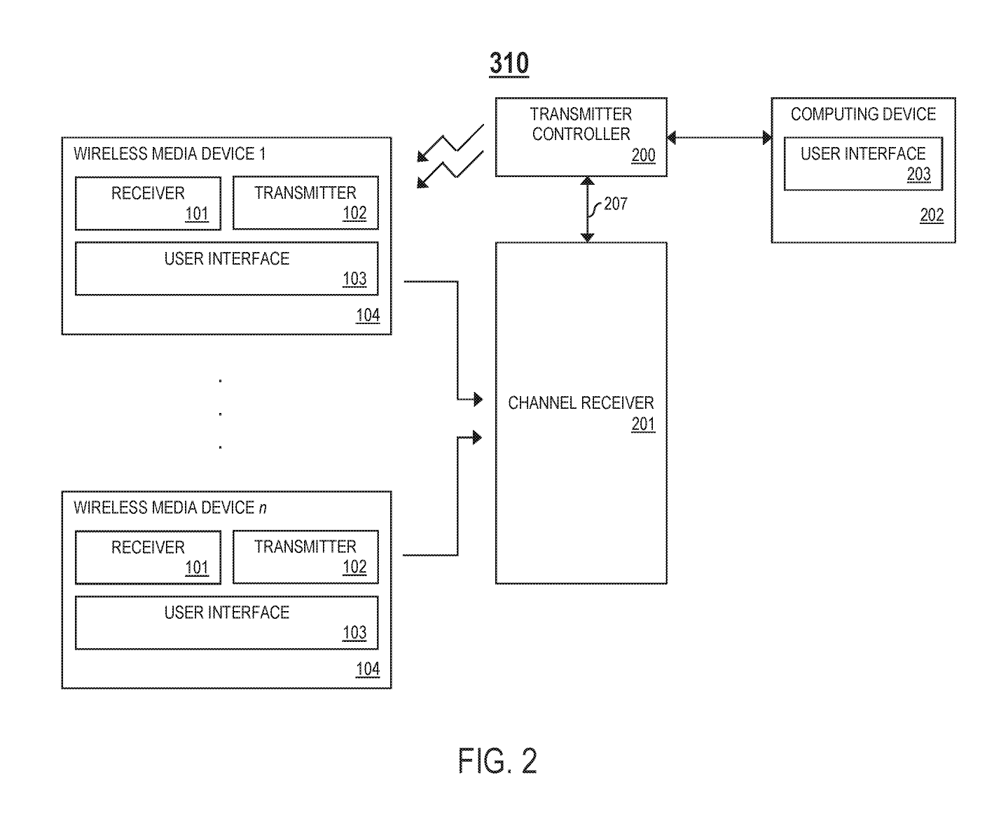

FIG. 2 illustrates another example wireless system 310 for dynamic allocation of wireless channels for applications, wherein the system 310 includes a feedback loop 207, in accordance with one embodiment. The system 310 is similar to the system 100 in FIG. 1. However, unlike the system 100, the system 310 further comprises the feedback loop 207 in which the transmitter controller 200 exchanges data with the channel receiver 201 over a point-to-point connection (e.g., a wireless connection such as a WiFi connection or a cellular data connection, a wired connection, or a combination of the two).

For example, the transmitter controller 200 is configured to receive feedback information from the channel receiver 201. Specifically, in response to receiving a control command from the transmitter controller 200, a wireless media device 104 is configured to wirelessly transmit an acknowledgment packet to the channel receiver 201. The acknowledgment packet comprises a limited amount of data (e.g., at least 1 bit) acknowledging receipt of the control command. For example, if a control command received at a wireless media device 104 comprises an instruction for the wireless media device 104 to power off (i.e., turn off or deactivate), the wireless media device 104 transmits an acknowledgment packet to the channel receiver 201 acknowledging receipt of the instruction to power off. In response to receiving the acknowledgement packet from the wireless media device 104, the channel receiver 201 forwards the acknowledgment packet to the transmitter controller 200 that in turn forwards the acknowledgement packet to the computing device 202. The feedback loop 207 increases robustness of the system 310, enabling confirmation that the wireless media device 104 assigned to a particular transmission channel has powered off (i.e., is deactivated) before allowing another wireless media device 104 to utilize the same transmission channel.

As another example, if a control command received at a wireless media device 104 comprises an instruction for the wireless media device 104 to power on (i.e., turn on), the wireless media device 104 transmits an acknowledgment packet to the channel receiver 201 acknowledging receipt of the instruction to power on. In response to receiving the acknowledgement packet from the wireless media device 104, the channel receiver 201 forwards the acknowledgment packet to the transmitter controller 200 that in turn forwards the acknowledgement packet to the computing device 202. The feedback loop 207 increases robustness of the system 310, enabling confirmation that the wireless media device 104 assigned to a particular transmission channel is active (i.e., activated) on the transmission channel after receiving the instruction to power on.

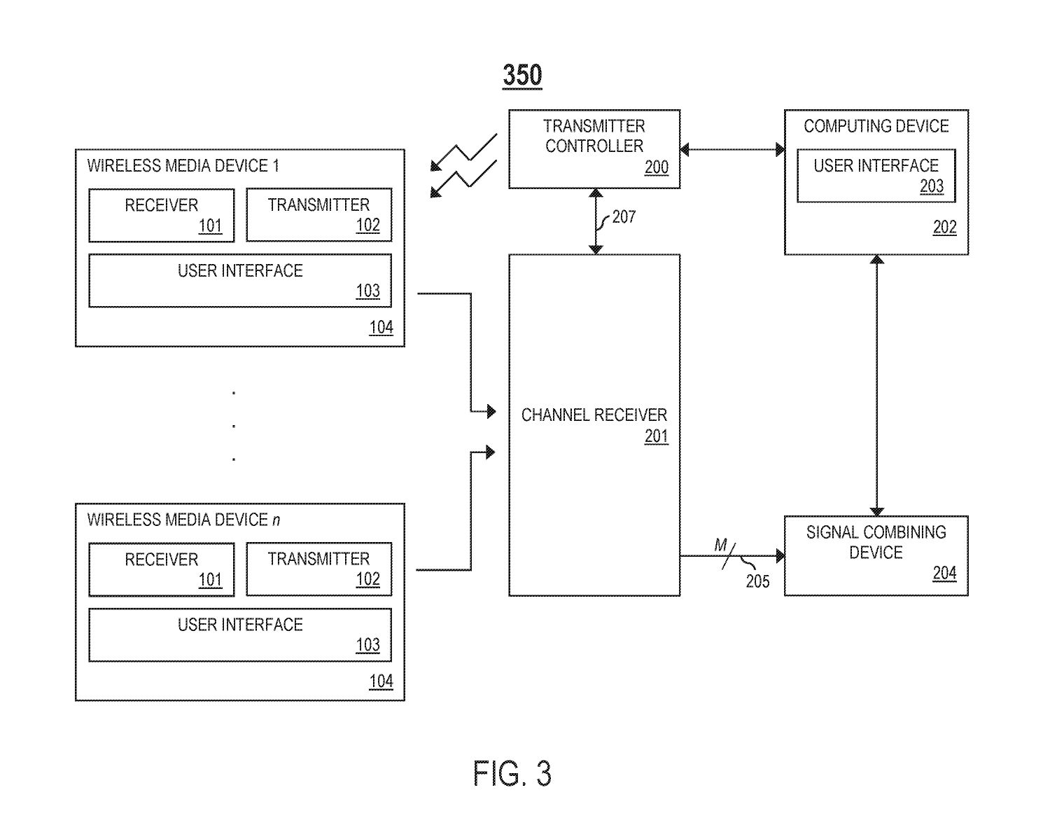

FIG. 3 illustrates another example wireless system 350 for dynamic allocation of wireless channels for applications, wherein the system 350 includes a signal combining device 204, in accordance with one embodiment. The system 350 is similar to the system 310 in FIG. 2. However, unlike the system 310, the system 350 further comprises the signal combining device 204. The signal combining device 204 is a media device. In one embodiment, the signal combining device 204 is an audio mixer.

The channel receiver 201 is connected to the signal combining device 204 via a communication bus 205 comprising M channels, wherein M>1. In one embodiment, the communication bus 205 is an audio bus comprising M audio channels.

In one embodiment, if the channelization protocol utilized is FDMA, the number of channels (i.e., M) included in the communication bus 205 will be limited to the number of individual wireless media devices 104 tuned to a particular transmission channel, which is typically equal to the number of transmission channels available for use by the wireless media devices 104.

In one embodiment, the signal combining device 204 is configured to exchange data with the computing device 202 over a point-to-point connection (e.g., a wireless connection such as a WiFi connection or a cellular data connection, a wired connection, or a combination of the two). For example, the signal combining device 204 may communicate with the computing device 202 to request that a particular wireless media device 104 is either: (1) powered on, or (2) powered to a particular transmission channel, thereby ensuring data/signals (e.g., audio data/signals) transmitted by the wireless media device 104 is routed to an appropriate channel (e.g., audio channel) of the communication bus 205. This connection between the signal combining device 204 and the computing device 202 is optional, but may expand functionality and ease of use of the system 350.

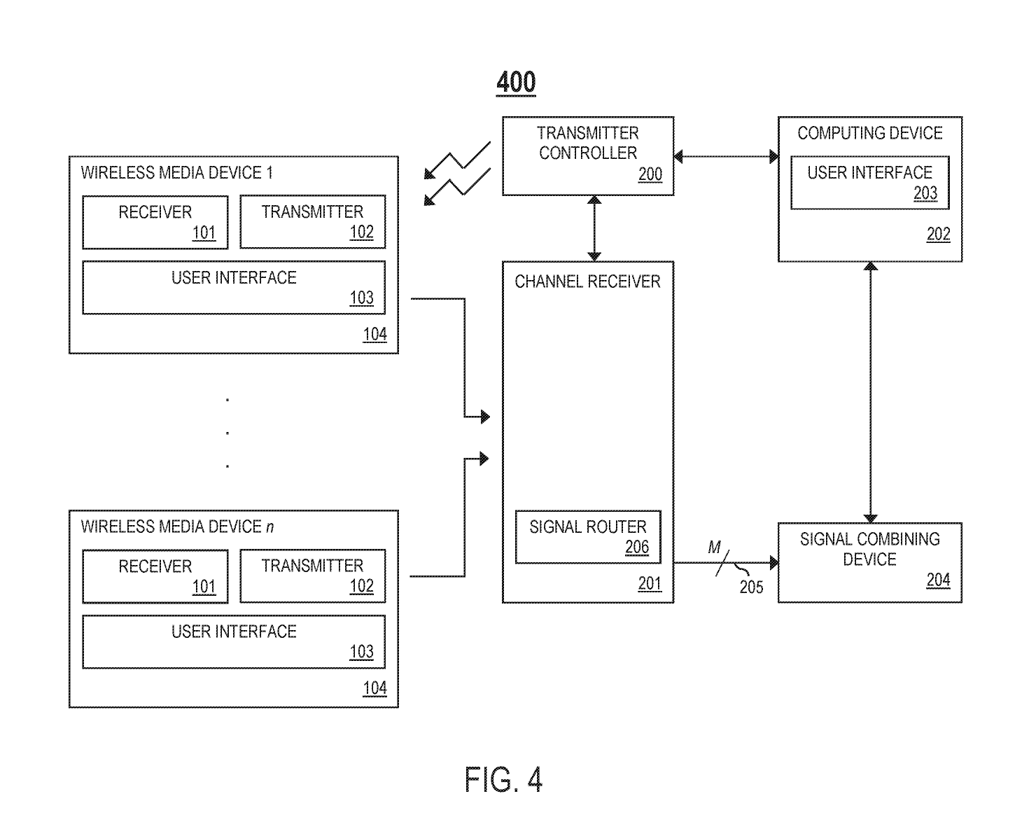

FIG. 4 illustrates another example wireless system 400 for dynamic allocation of wireless channels for applications, wherein the system 400 includes a signal router 206, in accordance with one embodiment. The system 400 is similar to the system 350. However, unlike the system 350, the system 400 further comprises the signal router 206 integrated in/combined with the channel receiver 201. The signal router 206 is configured to: (1) receive signals on a particular transmission channel from a particular wireless media device 104, and (2) route the signals received to an appropriate channel of the communication bus 205 based on a corresponding ID of the wireless media device 104 (i.e., signal routing). In one embodiment, the signal router 206 is an audio signal router configured to route audio signals received on a particular transmission channel from a particular wireless media device 104 to an appropriate audio channel of the communication bus 205 based on a corresponding ID of the wireless media device 104.

In one embodiment, the number of channels (i.e., M) included in the communication bus 205 may exceed the number of transmission channels available for use by the wireless media devices 104. For example, if there are only 24 TDMA transmission channels available and an event requires 64 wireless media devices 104, a standard 64 channel digital link (e.g., AES10 (MADI) for audio signals) may be used as the communication bus 205. Each of the 64 wireless media devices 104 is assigned a unique ID (e.g., an ID in the range of 1 to 64). A user/operator (e.g., an audio/sound operator) tasked with managing the system 400 may activate up to 24 of the wireless media devices 104 at a time (e.g., via the computing device 202). Each wireless media device 104 selected to activate at a particular time during the event is wirelessly instructed, via the transmitter controller 200, to power on. For each active wireless media device 104, the computing device 202 assigns a particular transmission channel from the 24 TDMA transmission channels available to the wireless media device 104. At the channel receiver 201, signals received from an active wireless media device 104 on an assigned transmission channel is mapped to a particular channel of the communication bus 205 that corresponds to an ID of the wireless media device 104. For example, if a wireless media device 104 with ID x is a wireless microphone and the channel receiver 201 is an audio channel receiver, the audio channel receiver maps audio signals received from the wireless microphone on an assigned transmission channel to an audio channel of the audio bus 205 that corresponds to the ID x.

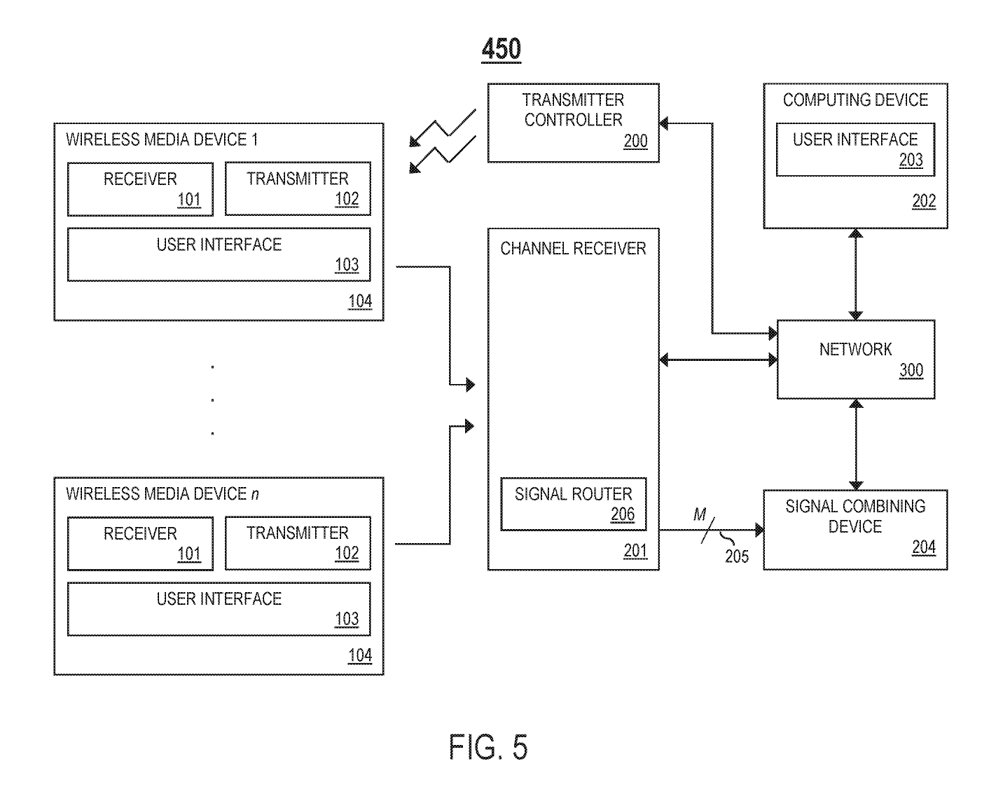

FIG. 5 illustrates another example wireless system 450 for dynamic allocation of wireless channels for applications, wherein the system 450 includes a network connection 300, in accordance with one embodiment. The system 450 is similar to system 400 in FIG. 4. However, unlike the system 400 where data is exchanged between the transmitter controller 200, the channel receiver 201, the computing device 202, and the signal combining device 204 via point-to-point connections, the system 450 further comprises the network connection 300 for exchanging data between the transmitter controller 200, the channel receiver 201, the computing device 202, and the signal combining device 204.

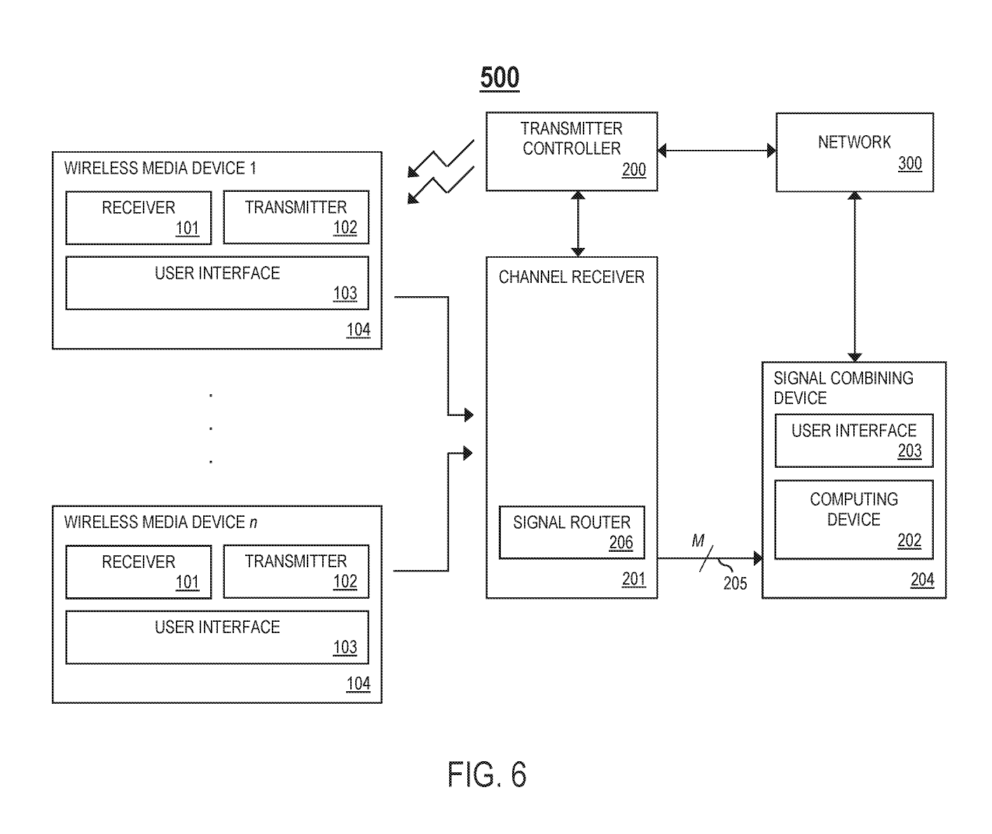

FIG. 6 illustrates another example wireless system 500 for dynamic allocation of wireless channels for applications, wherein the system 500 provides a signal combining device 204 with an on-board control surface, in accordance with one embodiment. The system 500 is similar to system 450 in FIG. 5. However, unlike the system 450 where the computing device 202 is separate from the signal combining device 204, the computing device 202 and the UI 203 in the system 500 are integrated in/combined with the signal combining device 204.

In the system 500, the computing device 202 and the UI 203 provide, at the signal combining device 204, an on-board control surface that a user/operator (e.g., an audio/sound operator) tasked with managing the system 500 may use for: (1) selecting/communicating with one or more wireless media devices 104 the user/operator needs to have active (i.e., powered on and transmitting signals) at a particular time during an event, and/or (2) managing assignment of transmission channels available for use by the wireless media devices 104.

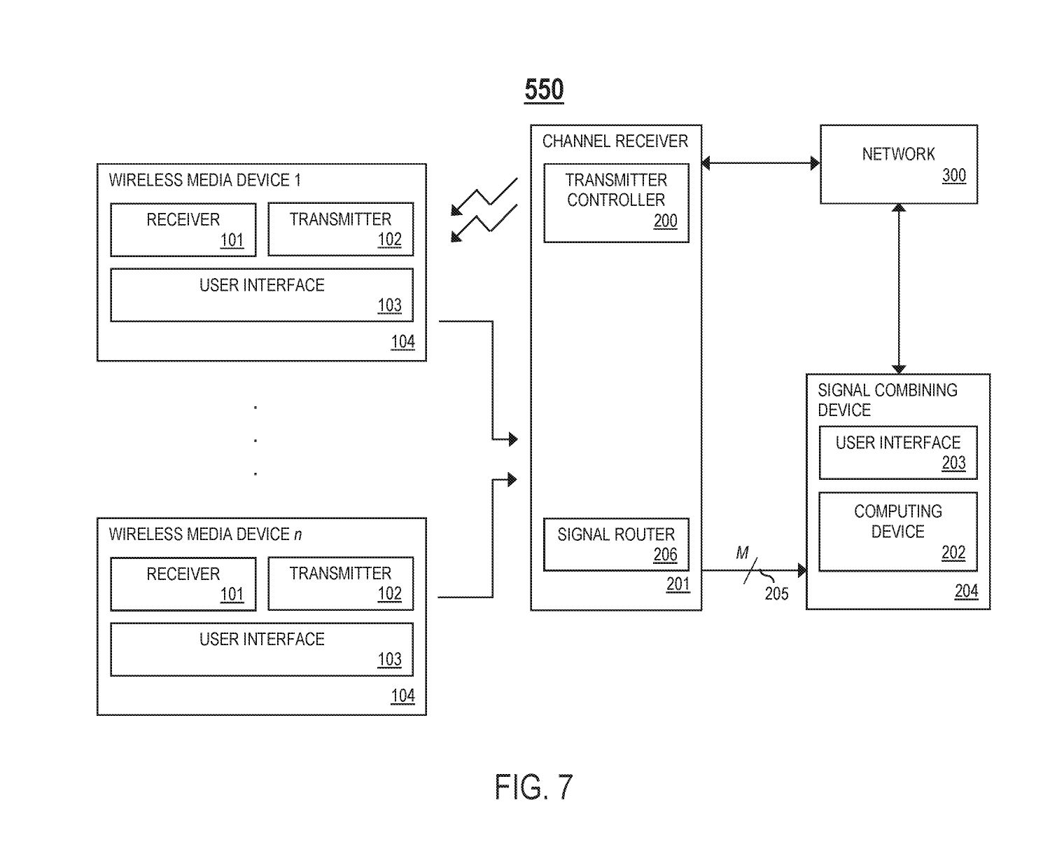

FIG. 7 illustrates another example wireless system 550 for dynamic allocation of wireless channels for applications, wherein the system 550 provides a transmitter controller 200 integrated with a channel receiver 201, in accordance with one embodiment. The system 550 is similar to system 500 in FIG. 6. However, unlike the system 500, the transmitter controller 200 in the system 550 is integrated in/combined with the channel receiver 201.

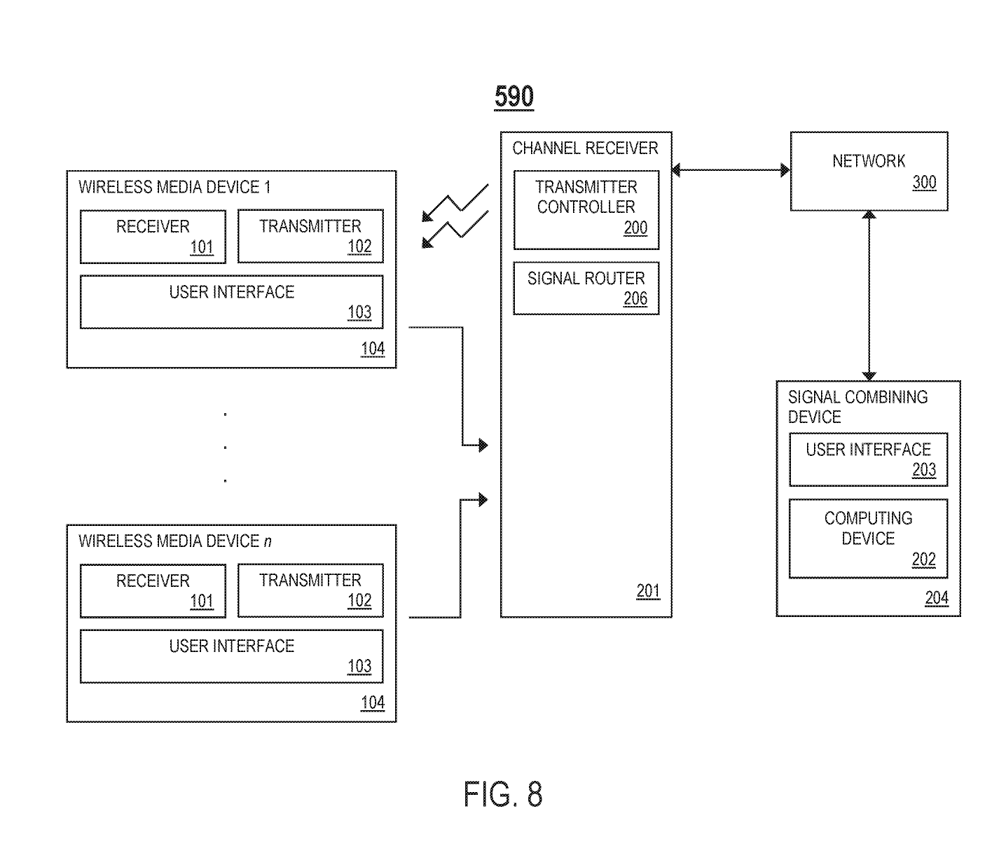

FIG. 8 illustrates another example wireless system 590 for dynamic allocation of wireless channels for applications, wherein the system 590 transfers signals over a network connection 300, in accordance with one embodiment. The system 590 is similar to system 550 in FIG. 7. However, unlike the system 550 where the communication bus 205 is used to transfer signals received at the channel receiver 201 from the wireless media devices 104, the signals in the system 590 are transferred over the same network connection 300 as control data. For example, low latency audio signals over IP allows multichannel audio to be transferred over the same network connection as control data.

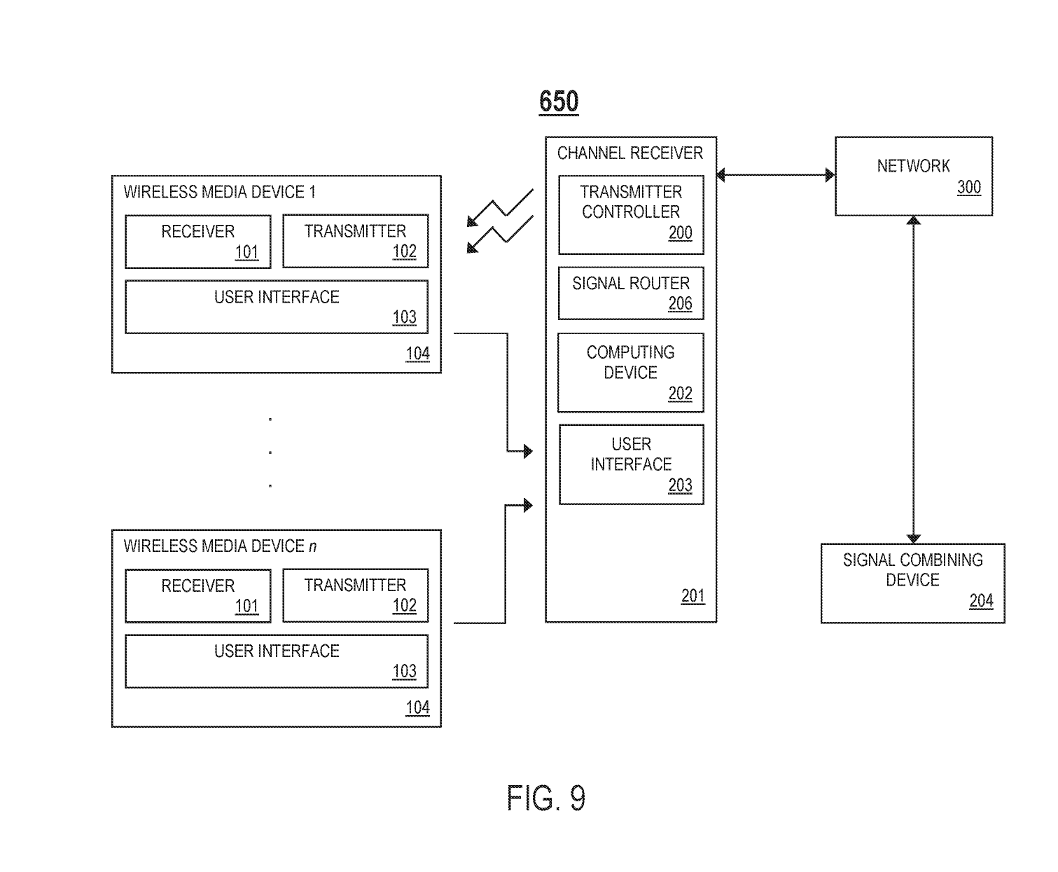

FIG. 9 illustrates another example wireless system 650 for dynamic allocation of wireless channels for applications, wherein the system 650 provides a channel receiver 201 with an on-board control surface, in accordance with one embodiment. The system 650 is similar to system 590 in FIG. 8. However, unlike the system 590 where the computing device 202 and the UI 203 are integrated in/combined with the signal combining device 204, the computing device 202 and the UI 203 in the system 650 are integrated in/combined with the channel receiver 201.

In the system 650, the computing device 202 and the UI 203 provide, at the channel receiver 201, an on-board control surface that a user/operator (e.g., an audio/sound operator) tasked with managing the system 650 may use for: (1) selecting/communicating with one or more wireless media devices 104 the user/operator needs to have active (i.e., powered on and transmitting signals) at a particular time during an event, (2) managing assignment of transmission channels available for use by the wireless media devices 104, and (3) signal routing (i.e., routing of signals received from a wireless media device 104 on an assigned transmission channel).

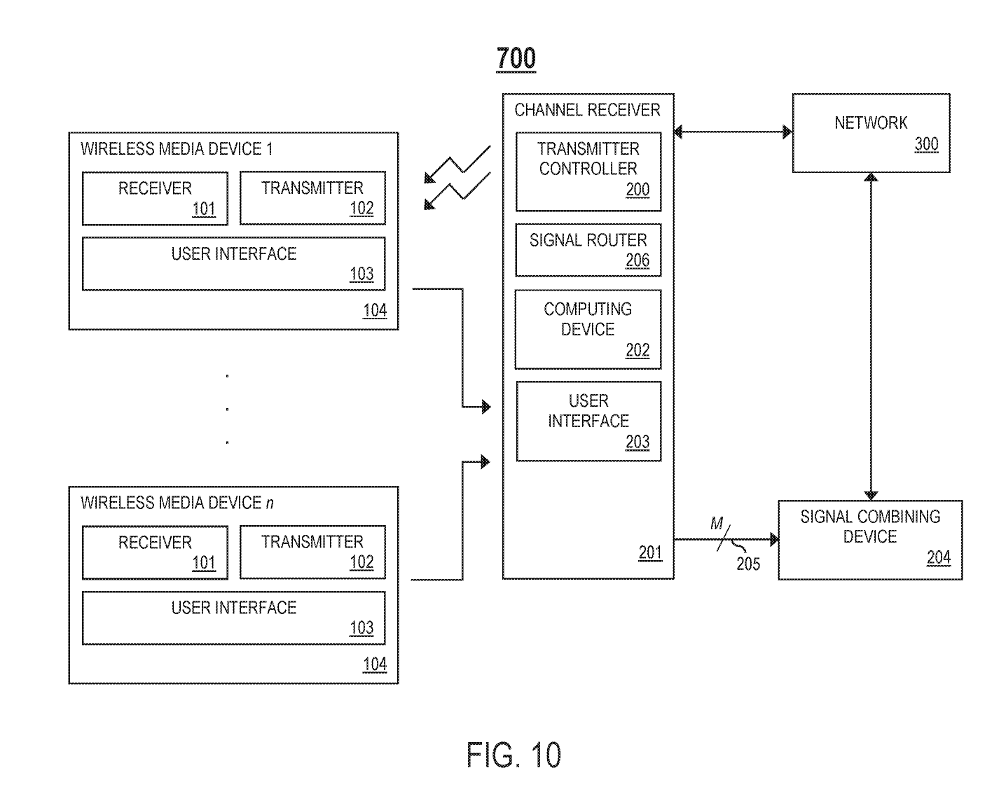

FIG. 10 illustrates another example wireless system 700 for dynamic allocation of wireless channels for applications, wherein the system 700 transfers signals over a communication bus 205, in accordance with one embodiment. The system 700 is similar to system 650 in FIG. 9. However, unlike the system 650 where signals received at the channel receiver 201 from the wireless media devices 104 is transferred over the network connection 300 as networked data, the signals received at the channel receiver 201 in the system 700 are transferred to the signal combining device 204 via the separate communication bus 205.

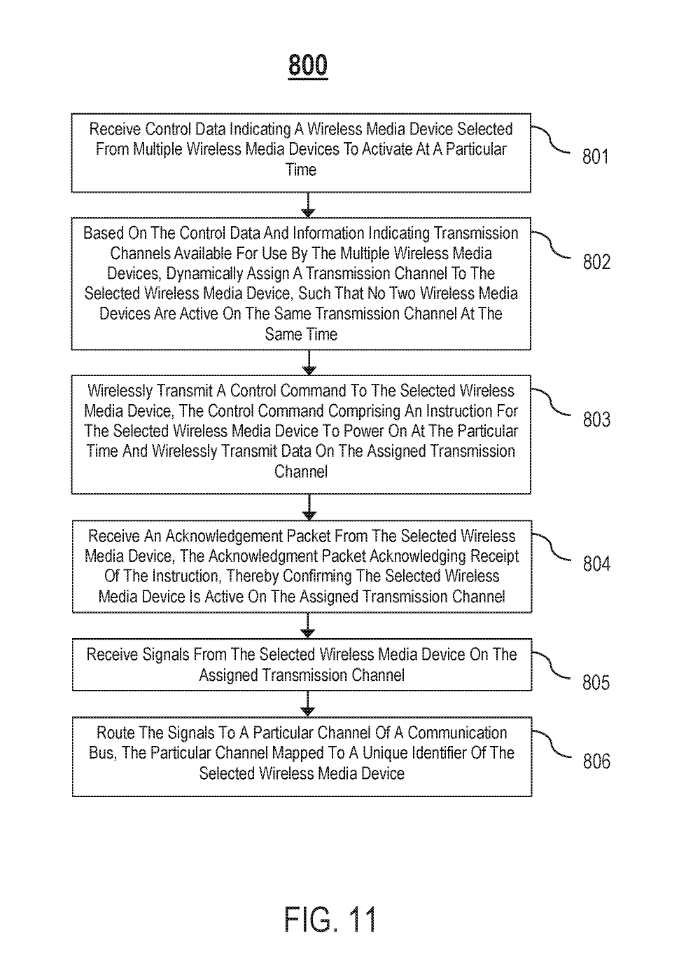

FIG. 11 illustrates a flowchart of an example process 800 for dynamic allocation of wireless channels for applications, in accordance with one embodiment. In process block 801, receive control data indicating a wireless media device selected from multiple wireless media devices to activate at a particular time. In process block 802, based on the control data and information indicating transmission channels available for use by the multiple wireless media devices, dynamically assign a transmission channel to the selected wireless media device, such that no two wireless media devices are active on the same transmission channel at the same time. In process block 803, wirelessly transmit a control command to the selected wireless media device, the control command comprising an instruction for the selected wireless media device to power on (i.e., turn on or activate) at the particular time and wirelessly transmit data on the assigned transmission channel. In process block 804, receive an acknowledgement packet from the selected wireless media device, the acknowledgment packet acknowledging receipt of the instruction, thereby confirming the selected wireless media device is active on the assigned transmission channel. In process block 805, receive signals from the selected wireless media device on the assigned transmission channel. In process block 806, route the signals to a particular channel of a communication bus, the particular channel mapped to a unique identifier of the selected wireless media device.

In one embodiment, process blocks 801-806 may be performed utilizing at least one of the transmitter controller 200 and the channel receiver 201.

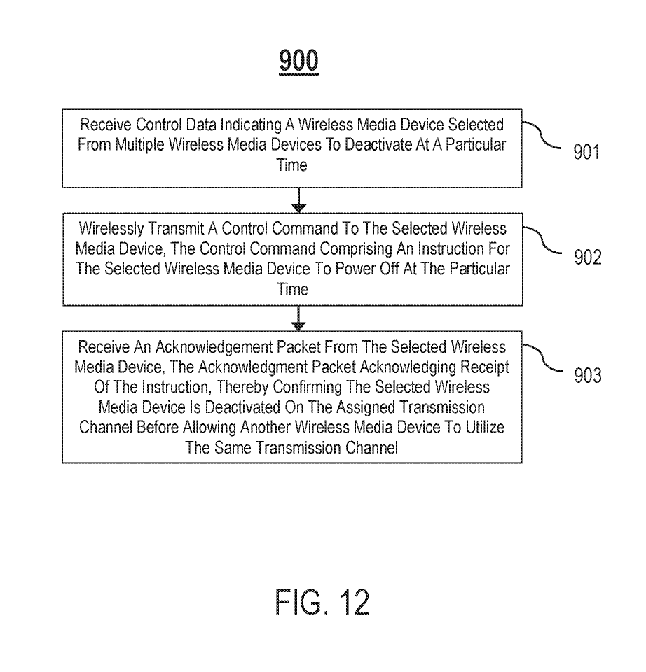

FIG. 12 illustrates a flowchart of another example process 900 for dynamic allocation of wireless channels for applications, in accordance with one embodiment. In process block 901, receive control data indicating a wireless media device selected from multiple wireless media devices to deactivate at a particular time. In process block 902, wirelessly transmit a control command to the selected wireless media device, wherein the control command comprises an instruction for the selected wireless media device to power off at the particular time. In process block 903, receive an acknowledgment packet from the selected wireless media, the acknowledgment packet acknowledging receipt of the instruction, thereby confirming the selected wireless media device is deactivated on an assigned transmission channel before allowing another wireless media device to utilize the same transmission channel.

In one embodiment, process blocks 901-903 may be performed utilizing at least one of the transmitter controller 200 and the channel receiver 201.

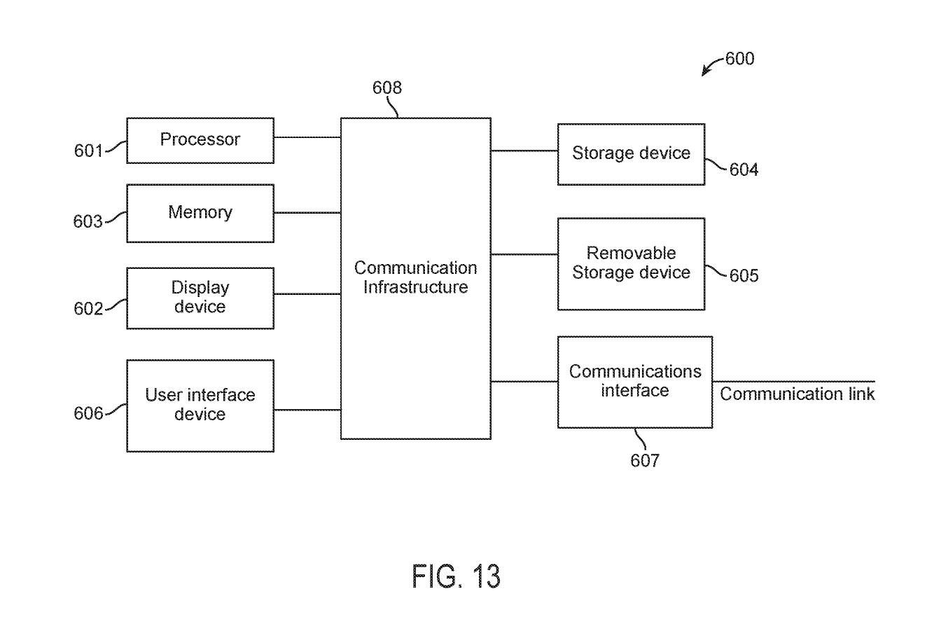

FIG. 13 is a high-level block diagram showing an information processing system comprising a computer system 600 useful for implementing the disclosed embodiments. The computer system 600 includes one or more processors 601, and can further include an electronic display device 602 (for displaying video, graphics, text, and other data), a main memory 603 (e.g., random access memory (RAM)), storage device 604 (e.g., hard disk drive), removable storage device 605 (e.g., removable storage drive, removable memory module, a magnetic tape drive, optical disk drive, computer readable medium having stored therein computer software and/or data), user interface device 606 (e.g., keyboard, touch screen, keypad, pointing device), and a communication interface 607 (e.g., modem, a network interface (such as an Ethernet card), a communications port, or a PCMCIA slot and card). The main memory 603 may store instructions that when executed by the one or more processors 601 cause the one or more processors 601 to perform one or more process blocks of the process 800 and the process 900.

The communication interface 607 allows software and data to be transferred between the computer system and external devices. The system 600 further includes a communications infrastructure 608 (e.g., a communications bus, cross-over bar, or network) to which the aforementioned devices/modules 601 through 607 are connected.

Information transferred via communications interface 607 may be in the form of signals such as electronic, electromagnetic, optical, or other signals capable of being received by communications interface 607, via a communication link that carries signals and may be implemented using wire or cable, fiber optics, a phone line, a cellular phone link, a radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process. In one embodiment, processing instructions for one or more process blocks of process 800 (FIG. 11) and process 900 (FIG. 12) may be stored as program instructions on the memory 603, storage device 604 and the removable storage device 605 for execution by the processor 601.

Embodiments have been described with reference to flowchart illustrations and/or block diagrams of methods, apparatus (systems) and computer program products. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

As will be appreciated by one skilled in the art, aspects of the embodiments may be embodied as a system, method or computer program product. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of one or more embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of one or more embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the invention.

Though the embodiments have been described with reference to certain versions thereof; however, other versions are possible. Therefore, the spirit and scope of the appended claims should not be limited to the description of the preferred versions contained herein.

What is claimed is:

1. A method for dynamic allocation of wireless channels for applications, comprising:
receiving first control data indicating a first wireless media device selected from multiple wireless media devices to activate at a first pre-determined time;
based on the first control data and information indicating transmission channels available for use by the multiple wireless media devices, dynamically assigning a first transmission channel to the first wireless media device, such that no two wireless media devices are active on the same transmission channel at the same time; and
wirelessly transmitting a first control command to the first wireless media device, wherein the first control command comprises a first instruction for the first wireless media device to power on at the first pre-determined time and wirelessly transmit data on the first transmission channel.

2. The method of claim 1, further comprising:
receiving a first acknowledgement packet originating from the first wireless media device, wherein the first acknowledgment packet acknowledges receipt of the first instruction, thereby confirming the first wireless media device is active on the first transmission channel.

3. The method of claim 1, wherein signals wirelessly transmitted by the first wireless media device on the first transmission channel are routed to a first channel of a communication bus, and the first channel of the communication bus is mapped to a unique identifier of the first wireless media device.

4. The method of claim 1, further comprising:
receiving second control data indicating a second wireless media device selected from the multiple wireless media devices to deactivate at a second pre-determined time; and
wirelessly transmitting a second control command to the second wireless media device, wherein the second control command comprises a second instruction for the second wireless media device to power off at the second pre-determined time.

5. The method of claim 4, further comprising:
receiving a second acknowledgement packet originating from the second wireless media device, wherein the second acknowledgment packet acknowledges receipt of the second instruction, thereby confirming the second wireless media device is deactivated on an assigned transmission channel before allowing another wireless media device to utilize the same transmission channel.

6. The method of claim 4, wherein the first wireless media device and the second wireless media device are the same wireless media device.

7. The method of claim 4, wherein the first wireless media device and the second wireless media device are different wireless media devices.

8. The method of claim 4, wherein each wireless media device comprises a wireless microphone.

9. The method of claim 3, wherein the communication bus comprises an audio bus including multiple audio channels, and each assigned transmission channel is mapped to an audio channel of the audio bus that corresponds to a unique identifier of a wireless media device assigned the transmission channel.

10. A system for dynamic allocation of wireless channels for applications, comprising:
at least one processor; and
a non-transitory processor-readable memory device storing instructions that when executed by the at least one processor causes the at least one processor to perform operations including:
receiving first control data indicating a first wireless media device selected from multiple wireless media devices to activate at a first pre-determined time;
based on the first control data and information indicating transmission channels available for use by the multiple wireless media devices, dynamically assigning a first transmission channel to the first wireless media device, such that no two wireless media devices are active on the same transmission channel at the same time; and
wirelessly transmitting a first control command to the first wireless media device, wherein the first control command comprises a first instruction for the first wireless media device to power on at the first pre-determined time and wirelessly transmit data on the first transmission channel.

11. The system of claim 10, the operations further comprising:
receiving a first acknowledgement packet originating from the first wireless media device, wherein the first acknowledgment packet acknowledges receipt of the first instruction, thereby confirming the first wireless media device is active on the first transmission channel.

12. The system of claim 10, wherein signals wirelessly transmitted by the first wireless media device on the first transmission channel are routed to a first channel of a communication bus, and the first channel of the communication bus is mapped to a unique identifier of the first wireless media device.

13. The system of claim 10, the operations further comprising:
receiving second control data indicating a second wireless media device selected from the multiple wireless media devices to deactivate at a second pre-determined time; and
wirelessly transmitting a second control command to the second wireless media device, wherein the second control command comprises a second instruction for the second wireless media device to power off at the second pre-determined time.

14. The system of claim 13, the operations further comprising:
receiving a second acknowledgement packet originating from the second wireless media device, wherein the second acknowledgment packet acknowledges receipt of the second instruction, thereby confirming the second wireless media device is deactivated on an assigned transmission channel before allowing another wireless media device to utilize the same transmission channel.

15. The system of claim 13, wherein the first wireless media device and the second wireless media device are the same wireless media device.

16. The system of claim 13, wherein the first wireless media device and the second wireless media device are different wireless media devices.

17. The system of claim 13, wherein each wireless media device comprises a wireless microphone.

18. The system of claim 12, wherein the communication bus comprises an audio bus including multiple audio channels, and each assigned transmission channel is mapped to an audio channel of the audio bus that corresponds to a unique identifier of a wireless media device assigned the transmission channel.

19. A non-transitory computer readable storage medium including instructions to perform a method for dynamic allocation of wireless channels for applications, the method comprising:
receiving first control data indicating a first wireless media device selected from multiple wireless media devices to activate at a first pre-determined time;
based on the first control data and information indicating transmission channels available for use by the multiple wireless media devices, dynamically assigning a first transmission channel to the first wireless media device, such that no two wireless media devices are active on the same transmission channel at the same time; and
wirelessly transmitting a first control command to the first wireless media device, wherein the first control command comprises a first instruction for the first wireless media device to power on at the first pre-determined time and wirelessly transmit data on the first transmission channel.

20. The non-transitory computer readable storage medium of claim 19, wherein signals wirelessly transmitted by the first wireless media device on the first transmission channel are routed to a first channel of a communication bus, and the first channel of the communication bus is mapped to a unique identifier of the first wireless media device.
